(19) United States
(12) Patent Application Publication
(10) Pub. No.: US 2020/0226231 A1
(43) Pub. Date: Jul. 16, 2020

(54) System for Obfuscating Content in Shared Documents

(71) Applicant: Microsoft Technology Licensing, LLC, Redmond, WA (US)

(72) Inventors: Pranish Atul Kumar, Redmond, WA (US); Jered D. Aasheim, Eugene, OR (US); Paul Fraedrich Estes, Bellevue, WA (US); Keith Douglas Senzel, Seattle, WA (US); Peter E. Loforte, Issaquah, WA (US)

(21) Appl. No.: 16/247,410

(22) Filed: Jan. 14, 2019

(51) Int. Cl. G06F 21/14; G06F 17/21; G06F 17/24

(52) U.S. Cl. CPC G06F 21/14; G06F 17/243; G06F 17/212

(57) ABSTRACT

A method may include identifying a set of original data items, to be obfuscated, in a first version of a document associated with a first user; mapping the set of original data items to a set of obfuscated data items, the set of obfuscated data items being obfuscated versions of the set of original data items; generating a second version of the document with the set of obfuscated data items in place of the original data items; transmitting the second version of the document to a second user: receiving a third version of the document from the second user with changes made to the second version; and using the mapping, composing a fourth version of the document by merging the changes in the third. version with the original set of data items in place of the set of obfuscated data items.

### BACKGROUND

Document authoring software may permit a first user to share a document with a second user for editing. For example, the document authoring software may include server-side access controls that allow the first user to permit the second user to edit the document. In some instances, the first user may require the assistance of the second user to edit the document for design layout and general readability purposes. For example, the second user may have expertise in creating more visually pleasing presentations than the first user. The document the second user edits may include all of the data the first user entered including, potentially, sensitive or confidential information.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1. is a schematic diagram of components of a document obfuscation system, according to various examples.

FIG. 2 is a representation of a document, according to various examples.

FIG. 3 is a representation of a mapping table, according to various examples.

FIG. 4 is a representation of a document with certain content obfuscated, according to various examples.

FIG. 5 is a representation of an edited document with certain content obfuscated, according to various examples.

FIG. 6 is a representation of a document, according to various examples.

FIG. 7 is a flowchart diagram illustrating operations of a method, according to various examples.

FIG. 8 is a block diagram illustrating an example machine upon which any one or more of the techniques (e.g., methodologies) discussed herein may be performed, according to an example embodiment.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device accessible by the component via an API or other program communication method. Similarly, the variables may be assumed to have a default values should a specific value not be described. User interfaces may be provided for an end-user or administrator to edit the variable values in some instances.

It is not uncommon for a first user to create a substantive portion (e.g., the text, analysis, etc.) of a document and a second user to work on the presentation (e.g., font selection, graphic placement, etc.). One of the problems, however, is that the substantive portion often include sensitive information. This reduces the amount of users that are available to perform the presentation editing work. Indeed, in many cases, the presentation work is not dependent on the specific text within the document. Examples include designing a presentation slide, creating a timeline or producing a wireframe/design.

Obfuscation software that permits sensitive data to be hidden from the second user suffers from certain problems. First, obfuscation software is often a one-way translation that puts black-bars over sensitive data or uses one-way hashing algorithms. Thus, there is no mechanism to translate the obfuscated data back into its original form. A second, somewhat related problem, is that the obfuscation fails to maintain the formatting of the original data. Accordingly, the second user is unable to make intelligent decisions regarding presentation and formatting of a shared document.

In view of the above problems, it is clear that improvements are needed in user interface design and software-based translation techniques to permit non-destructive obfuscation techniques that maintain the formatting of any sensitive data. Systems are described herein that securely (e.g., using public/private key encryption) and automatically obfuscate content with a document. Then, after a second user has edited the document, the system may merge the presentation-based edits of the second user with the original sensitive content of the first user. To track the changes, a mapping table may be used that maps original content to obfuscated content. The mapping table may be used to reverse the obfuscation after the edits have been made by the second user to create a final document.

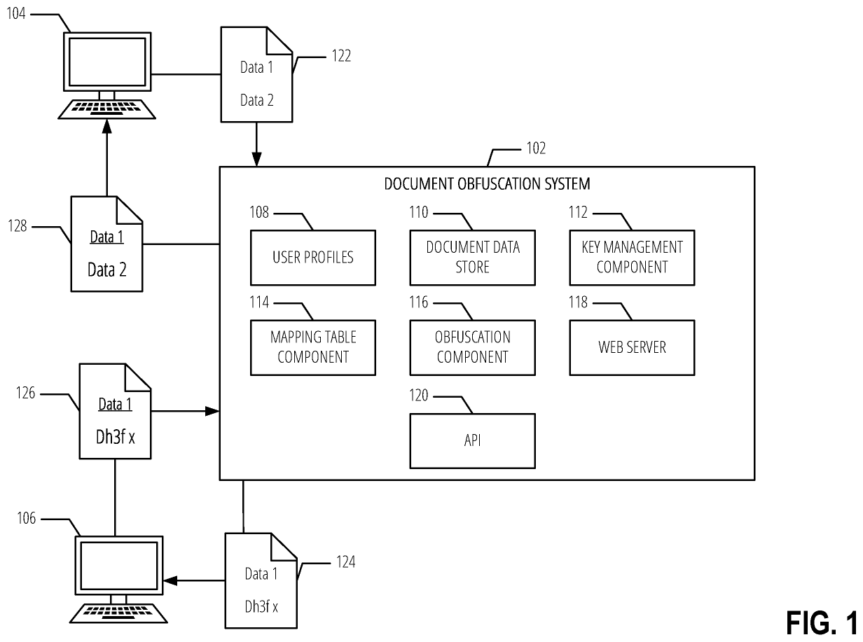

FIG. 1 is a schematic diagram of components of a document obfuscation system 102, according to various examples. FIG. 1 includes document obfuscation system 102, computing device 104, and computing device 106. Document obfuscation system 102 includes user profiles 108, document data store 110, key management component 112, mapping table component 114, obfuscated component 116, web server 118, and API 120. Additionally, FIG. 1 includes documents 122, 124, 126, 128.

For illustration purposes, document obfuscation system 102 is illustrated as set of separate functional units (e.g., the various components, web server 118, etc.). However, the functionality of multiple functional units may be performed by a single unit. A functional unit may represent computer program code that is executable by a processing unit (e.g., a core of a general-purpose computer processor, a graphical processing unit, an application specific integrated circuit, etc.) The program code may be stored on a storage device and loaded into a memory of the processing unit for execution. Portions of the program code may be executed in a parallel across multiple processing units. Execution of the code may be performed on a single device or distributed across multiple devices, in some example, the program code is executed on a cloud platform (e.g., MICROSOFT AZURE® and AMAZON EC2®) using shared computing infrastructure.

Computing devices 104 and 106 may be, but are not limited to, a smartphone, tablet, laptop, multi-processor system, microprocessor-based or programmable consumer electronics, game console, set-top box, or any other device that a user utilizes to communicate over a network to each other and document obfuscation system 102. A network may include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. A network may include a single local area network (LAN) or wide-area network (WAN), or combinations of LAN's or WAN's, such as the Internet.

In example embodiments, computing devices 104 and 106 include a display module (not shown) to display information (e.g., in the form of specially configured user interfaces). In some embodiments, the computing devices 104 and 106 may include one or more of a touch screen, camera, keyboard, and microphone. Computing device 104 may be associated with a first user that generates document 122. Computing device 106 may be associated with a second user that edits document 124 and transmits back document 126 to document obfuscation system 102. Document 128 may be transmitted back to computing device 104.

Web server 118 may be configured to serve data in the form of webpages or web applications to computing device 104 and computing device 106. In some examples, the web applications include document authoring software. Although generally discussed in the context of delivering webpages via the Hypertext Transfer Protocol (HTTP), other network protocols may be utilized by web servers 110 (e.g., File Transfer Protocol, Telnet, Secure Shell, etc.) A user may enter in a uniform resource identifier (URI) into a network browser (e.g., the INTERNET EXPLORER® web browser by Microsoft Corporation or SAFARI® web browser by Apple Inc.) that corresponds to the logical location (e.g., an Internet Protocol address) of one or more pages served by web server 118. In response, web server 118 may transmit a web page that is rendered on a display device of computing device 104 and computing device 106.

Document obfuscation system 102 may use or define one or more application programming interfaces (API) such as API 120. An API provides a method for computing processes or systems to exchange data. A web-based API, such as may be defined by document obfuscation system 102 and processed via web server 118 may permit users to upload and download documents document obfuscation system 102. For example, a user of document obfuscation system 102 may create and upload document 122 to document obfuscation system 102.

User profiles 108 may store data on users that interact with document obfuscation system 102. A user profile may be stored as user profile data structure. The user profile data structure may include a user identification for the user. Each user identification may be unique. The user identification may be comprised of alphanumeric characters. The user identification is an e-mail address, in an example. An entry in the user profile data structure may include credentials (e.g., user id, tokens, etc.) for the user.

Document data store 110 may store information on documents or documents themselves based on a document identifier. For example, document data store 110 may store access rights on documents authored by users. For example, document data store 110 may indicate (e.g., via a data entry) that document 122 is owned by a first user using the first user's user identification. Document data store 110 may further store an indication that the first user has given read and write privileges to a second user. The access rights may be more granular and indicate the second user is only allowed read and write access to the document if sensitive data is obfuscated.

Key management component 112 may generate and maintain public/private key pairs for document obfuscation. For example, each document may have at least one key pair. The private key may be used as a seed for transforming original data into obfuscated data. The public key may be attached to the document with the obfuscated data. The public key may serve two functions. First, it may be used as part of a digital signature to ensure authenticity. Second, it may be used to identify the private key when the document is recomposed with the original data. However, the public key may not be used to de-obfuscate the data.

If a document is shared a second time for editing by a third user, another public/private key pair may be generated. This may be useful if the second user is permitted to see a higher level (e.g., more sensitive) of data than the third user. Thus, the second user may mark even more data for obfuscation than the first user did.

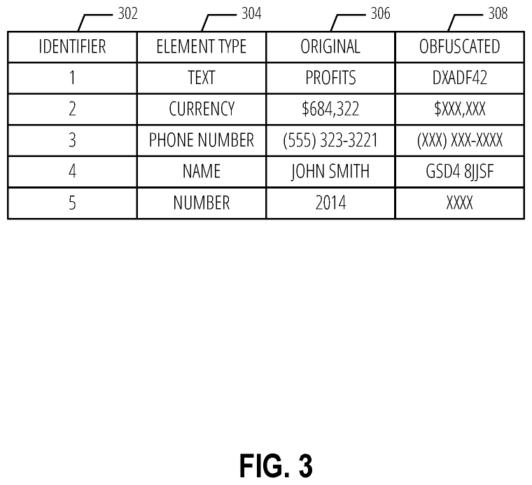

Mapping table component 114 may create a mapping table for each document that has or will obfuscate some data items (e.g., text, graphics, etc.). A mapping table may identify which data items of a document are obfuscated, where the data items are within the document, and the obfuscated version of the data item. For some elements, a pointer to the original data item is used instead of the data item itself. This may be useful to keep the size of the mapping table small when the data item is a graphic. As with public/private keys, there may be multiple mapping tables if the document is shared with more than one user. Mapping tables are discussed in more detail with respect to FIG. 3.

Obfuscated component 116 may transform an original data item into an obfuscated data item with formatting of the original data item maintained. The mapping table may store the output of data obfuscated by obfuscated component 116. Obfuscated component 116 may also automatically identify data items that a user may want to obfuscate, such as some types of personally identifying information. For example, using pattern matching such as regex, phone numbers, social security numbers, addresses, dollar amounts, etc., may be identified in a document for obfuscation. Other data items may be manually identified by a user for obfuscation. For example, a user may select a block of text and select a menu item to make it for obfuscation.

Different data items types may be obfuscated in different ways. For example, a phone number, may be obfuscated by using an ‘X’ for each number but otherwise leaving any punctuation. Dollar amounts may be treated as and found in a similar fashion as phone numbers. An image may be obfuscated by using a blank box that matches the size and position of the image. A timeline object may be obfuscated by changing dates into another form but maintaining the relative distance between each entry on the timeline.

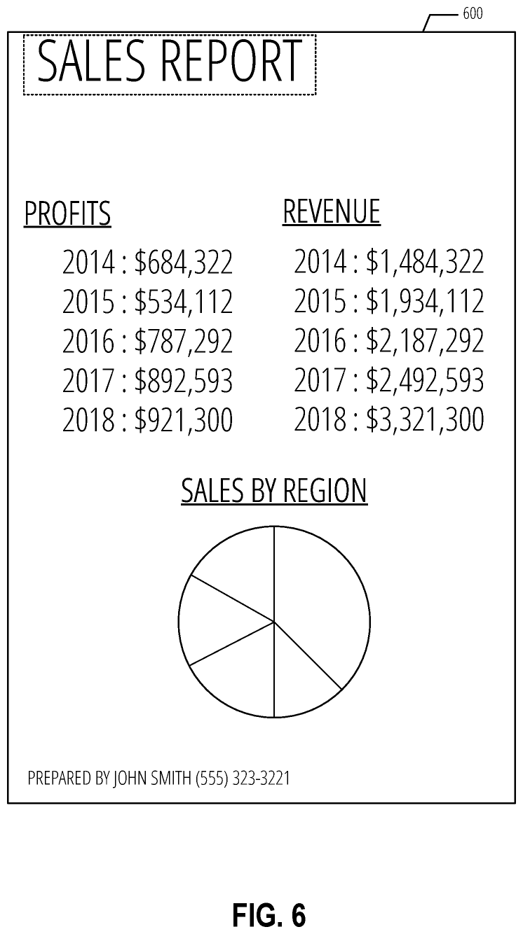

In various examples, free form text (e.g., text that doesn't match a pattern such as a phone number, may be transformed using a hash or other algorithm based on a seed using a private key for the document. Text may have its formatting retained such that the length of each word is maintained. Similarly, the size and style (e.g., bold, italics) may also be maintained during obfuscation. The size and style of the obfuscated text may be altered and applied to the original data upon recompositing the document (see e.g., FIG. 6).

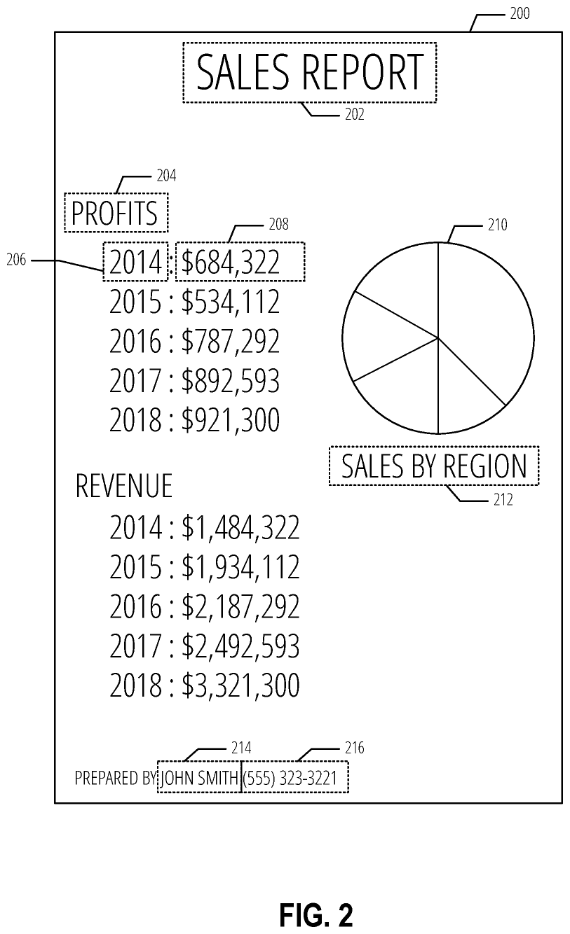

FIG. 2 is a representation of a document 200, according to various examples. Document 200 has a variety of data items identified such as title 202, heading 204, year 206, dollar amount 208, chart 210, chart title 212, name 214, and phone number 216.

Document 200 may be created by a first user. The first user may have a user identifier that is used when the document is created to associate the document to the first user. The first user may need help from a second user with the design of document 200 but does not want certain information shared with the second user. The second user may be someone outside of the same company the first user is working for or someone within the company that does not have clearance to see some of the data in document 200.

The first user may tag (e.g., via a menu item) in a content authoring application that certain items are to be obfuscated. For example, the first user may highlight year 206, dollar amount 208, chart 210, name 214, and phone number 216 and select an option for obfuscation and sharing to the second user. Title 202 and chart title 212 may not have been selected by the first user. In various examples, the content authoring application may have suggested certain items for obfuscation based on a set of stored regex patterns. An option to obfuscate the entire document may also be made available to the first user.

Upon indicating the items for obfuscation, document 200 may be uploaded to a cloud-based service such as document obfuscation system 102. Key management component 112 may generate a pair of private/public keys for obfuscation. Obfuscated component 116 may then perform the obfuscation of each of the selected data items. Mapping table component 114 may generate a mapping table that tracks each of the obfuscations made by obfuscated component 116.

FIG. 3 is a representation of a mapping table, according to various examples. The mapping table includes identifier column 302, element type column 304, original column 306, and obfuscated column 308. The structure and items in the mapping table are for illustration purposes only, and more or fewer columns may be used in a mapping table without departing from the scope of this disclosure. The mapping table includes example obfuscations for heading 204, dollar amount 208, phone number 216, name 214, and year 206 with respect to FIG. 2.

Identifier column 302 may store data associated with an identifier of a data element within a document. For example, document structure may include metadata or otherwise non-visible identification information for data within the documents. The value for an identifier may correspond to the identifier within the document. In some examples, the mapping table includes a location column that identifies the location within a document of the original data item. The location may be a set of (x, y) coordinates within the document or may be specified according to the Document Object Model, in various examples.

Values in element type column 304 may correspond to the type of the data item being obfuscated. The type may be determined based on metadata of the item within the document or by pattern matching. The value in element type column 304 may also be used to determine how to obfuscate the data item.

Original column 306 and obfuscated column 308 store the original and obfuscated may store the original and obfuscated versions of the data item. In some examples, the obfuscated versions are not required in a mapping table. Instead, the mapping table may store or otherwise identify the manner in which the obfuscated version was created. The information in the mapping table may be sufficient to reverse the obfuscation and recover the contents of the original data item.

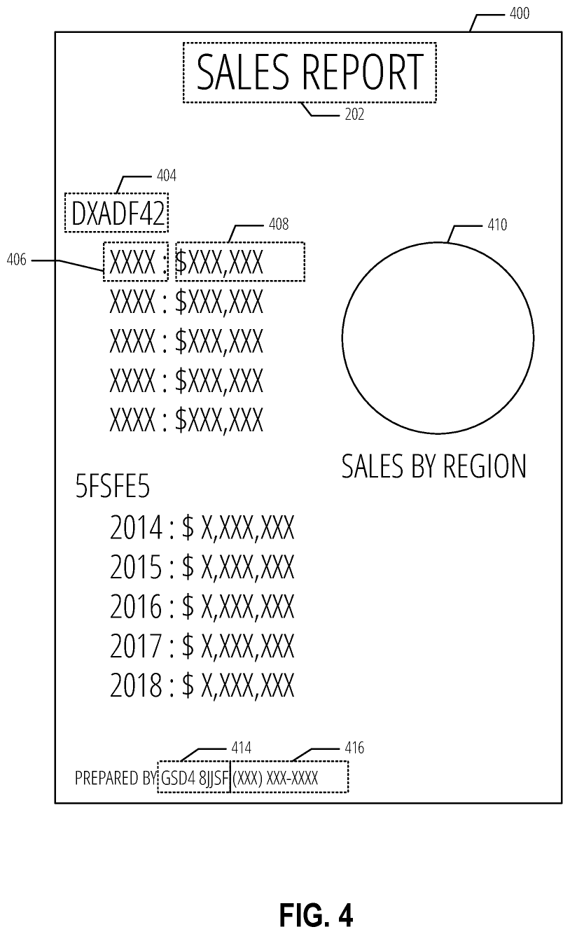

FIG. 4 is a representation of a document 400 with certain content obfuscated, according to various examples. Document 400 may be created by document obfuscation system 102 for editing by the second user. Document 400 may be sent to the second user with the public key associated with the private key created for the obfuscation. In some examples, document 400 is transmitted to the first user, who sends it to the second user.

As seen, title 202 remains unchanged; however, many of the other data items have been obfuscated. For example, chart 210 has been altered to produce chart 410. Chart 410 has maintained the outline of the pie chart of chart 210 but the “inside” of the chart is now blank. Heading 204 has been replaced with heading 204; however, the second user can see that the heading is seven letters and the size and style of the font. Year 206 and dollar amount 208 have been replaced with text 406 and dollar amount 408. The second user may readily be able to tell that these items relate to years and dollars amounts because the non-numbers have not been changed. Similarly, because not all of the text at the bottom of document 400 has been obfuscated, the second user will be able to tell that text 414 is likely a name and that item 416 is a phone number.

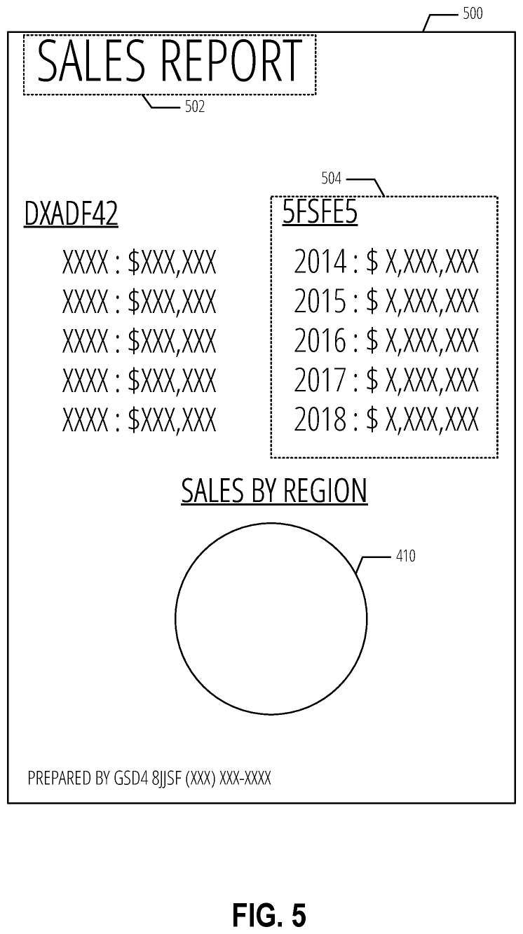

FIG. 5 is a representation of an edited document 500 with certain content obfuscated, according to various examples. The second user may take document 400 and transform it by changing its design. Design may include moving data items around, changing font sizes/styles, changing colors, etc. In some examples, the second user is prohibited from editing the content of obfuscated data items beyond deleting an item in its entirety. The first user may reject the change in some instances. As seen, the second user has increased the size of title 202 to title 502. The second user has also moved portion 504 when compared to its original position in document 200. Similarly, chart 410 has been moved to the lower portion of the document. The second user has also made a few formatting changes by bolding and underlying some of the headings.

After making the edits, the second user may transmit the document back to document obfuscation system 102. In some examples, the second user may transmit document 500 to the first user. When the first user opens document 500, the content authoring software may recognize that a public key is attached to the document and transmit a request to document obfuscation system 102 to recompose document 500 with the original data items but with the design changes made by the second user.

FIG. 6 is a representation of a document 600, according to various examples. Document 600 may represent a recompositing of document 200 with the design changes made in document 500. Recomposing may include using the mapping table to either lookup the original data items to replace the obfuscated items or reversing the translation made to an original data item.

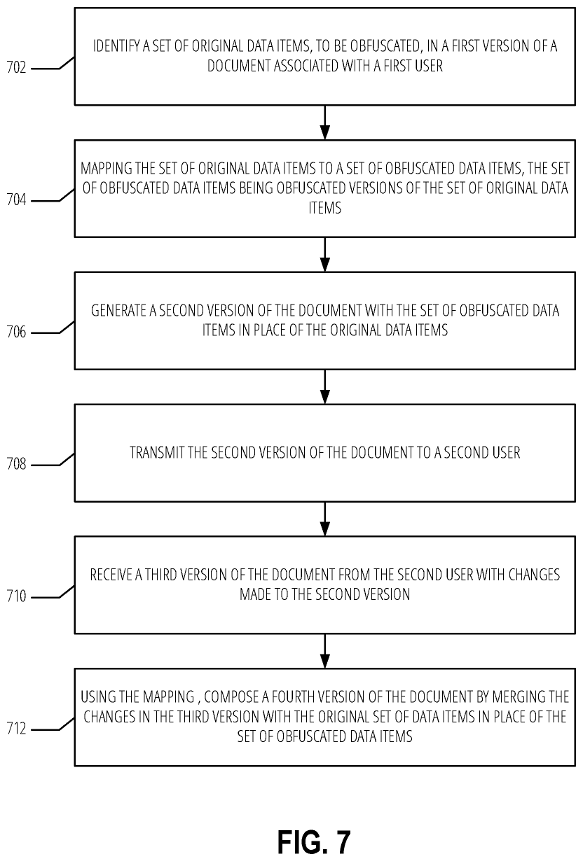

FIG. 7 is a flowchart diagram illustrating operations of a method, according to various examples. The method is represented as a set of blocks that describe operations 702-712 of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 7. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

In various examples, operation 702 includes identifying a set of original data items, to be obfuscated, in a first version of a document associated with a first user.

The operation of identifying the set of original data items may include identifying data items in the first version of the document that match a regular expression. Different regular expressions may be used to find different types of data such as phone numbers, social security numbers, etc. The operation of identifying the set of original data items may include identifying data items in the first version of the document that have been tagged for obfuscation by the first user. For example, a user may select a text or graphical element and select a menu item indicating the item is to be obfuscated.

In various examples, operation 704 includes mapping the set of original data items to a set of obfuscated data items. The set of obfuscated data items may be obfuscated versions of the set of original data items. Different types of data items may have been obfuscated in different ways. The mapping may include storing the mapping as a mapping table or other data structure that includes an identifier of each of the original data items and a location of each of the original data items in the first version of the document.

In various examples, operation 706 includes generating a second version of the document with the set of obfuscated data items in place of the original data items.

The operations may further include transforming the set of original data items in the first version of the document into the set of obfuscated data items using a private key associated with the document. For example, an encryption algorithm may be applied that uses the private key as a seed value. The second version of the document may be transmitted to the second user with a public key associated with the private key. The public key may be used to verify the authenticity of the document, but not de-obfuscate the obfuscated data items.

In various examples, the set of obfuscated data items in the second version of the document maintains the formatting of the set of original data items in the first version of the document. For example, the set of original data items may include a text data item and maintaining the formatting of the text data item may include maintaining the length of the text data item. In an example, the set of original data items includes a graphic data item and maintaining the formatting of the graphic data item includes maintaining the size of the graphic data item.

In various examples, operation 708 includes transmitting the second version of the document to a second user. In various examples, operation 710 includes receiving a third version of the document from the second user with changes made to the second version. The changes may include formatting changes and placement changes to either obfuscated data items or non-obfuscated data items. For example, the changes in the third version of the document may include a change in font for an obfuscated data item.

In various examples, operation 712 includes using the mapping, composing a fourth version of the document. The changes in the third version may be merged with the original set of data items in place of the set of obfuscated data items. For example, composing the fourth version may include applying the change in font to an original data items that corresponds to the obfuscated data item. Thus, if a font was changed on an obfuscated data item, the original data item would have its font changed.

### Example Computer System

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

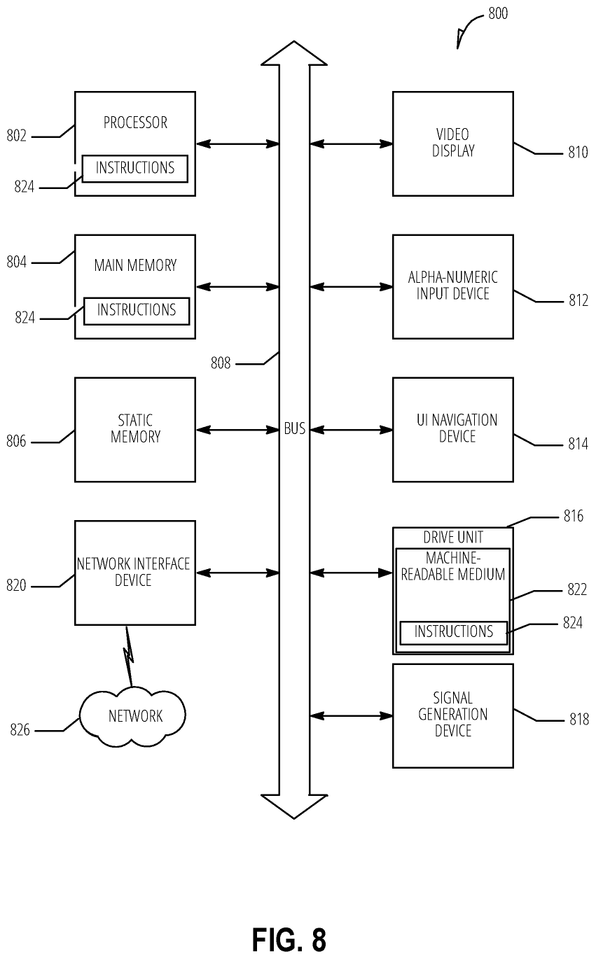

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g.; bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and U navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor; compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A system comprising:
at least one processor;
a storage device comprising instructions, which when executed by the at least one processor, configure the at least one processor to perform operations comprising:
identifying a set of original data items, to be obfuscated, in a first version of a document associated with a first user;
mapping the set of original data items to a set of obfuscated data items, the set of obfuscated data items being obfuscated versions of the set of original data items;
generating a second version of the document with the set of obfuscated data items in place of the original data items;
transmitting the second version of the document to a second user;
receiving a third version of the document from the second user with changes made to the second version; and
using the mapping, composing a fourth version of the document by merging the changes in the third version with the original set of data items in place of the set of obfuscated data items.

2. The system of claim 1, wherein the set of obfuscated data items in the second version of the document maintains the formatting of the set of original data items in the first version of the document.

3. The system of claim 2, wherein the set of original data items includes a text data item and wherein maintaining the formatting of the text data item includes maintaining the length of the text data item.

4. The system of claim 2, wherein the set of original data items includes a graphic data item and wherein maintaining the formatting of the graphic data item includes maintaining the size of the graphic data item.

5. The system of claim 1, wherein the operations further include:
transforming the set of original data items in the first version of the document into the set of obfuscated data items using a private key associated with the document.

6. The system of claim 5, wherein the second version of the document is transmitted to the second user with a public key associated with the private key.

7. The system of claim 1, wherein the mapping includes storing the mapping as a mapping table that includes an identifier of each of the original data items and a location of each of the original data items in the first version of the document.

8. The system of claim 1, wherein the changes in the third version of the document include a change in font for an obfuscated data item and wherein composing the fourth version includes applying the change in font to an original data items that corresponds to the obfuscated data item.

9. The system of claim 1, wherein the operation of identifying the set of original data items includes identifying data items in the first version of the document that match a regular expression.

10. The system of claim 1, wherein the operation of identifying the set of original data items includes identifying data items in the first version of the document that have been tagged for obfuscation by the first user.

11. A method comprising:
identifying a set of original data items, to be obfuscated, in a first version of a document associated with a first user;
mapping the set of original data items to a set of obfuscated data items, the set of obfuscated data items being obfuscated versions of the set of original data items;
generating a second version of the document with the set of obfuscated data items in place of the original data items;
transmitting the second version of the document to a second user;
receiving a third version of the document from the second user with changes made to the second version; and
using the mapping, composing a fourth version of the document by merging the changes in the third version with the original set of data items in place of the set of obfuscated data items.

12. The method of claim 11, wherein the set of obfuscated data items in the second version of the document maintains the formatting of the set of original data items in the first version of the document.

13. The method of claim 12, wherein the set of original data items includes a text data item and wherein maintaining the formatting of the text data item includes maintaining the length of the text data item.

14. The method of claim 12, wherein the set of original data items includes a graphic data item and wherein maintaining the formatting of the graphic data item includes maintaining the size of the graphic data item.

15. The method of claim 11, further including:
transforming the set of original data items in the first version of the document into the set of obfuscated data items using a private key associated with the document.

16. The method of claim 15, wherein the second version of the document is transmitted to the second user with a public key associated with the private key.

17. The method of claim 11, wherein the mapping includes storing the mapping as a mapping table that includes an identifier of each of the original data items and a location of each of the original data items in the first version of the document.

18. The method of claim 11, wherein the changes in the third version of the document include a change in font for an obfuscated data item and wherein composing the fourth version includes applying the change in font to an original data items that corresponds to the obfuscated data item.

19. The method of claim 11, wherein identifying the set of original data items includes identifying data items in the first version of the document that match a regular expression.

20. A storage device comprising instructions, which when executed by at least one processor, configure the at least one processor to perform operations comprising:
identifying a set of original data items, to be obfuscated, in a first version of a document associated with a first user;
mapping the set of original data items to a set of obfuscated data items, the set of obfuscated data items being obfuscated versions of the set of original data items;
generating a second version of the document with the set of obfuscated data items in place of the original data items;
transmitting the second version of the document to a second user;
receiving a third version of the document from the second user with changes made to the second version; and
using the mapping, composing a fourth version of the document by merging the changes in the third version with the original set of data items in place of the set of obfuscated data items.
